(19) United States
(12) Patent Application Publication
(10) Pub. No.: US 2024/0013050 A1
(43) Pub. Date: Jan. 11, 2024

(54) PACKING MACHINE LEARNING MODELS USING PRUNING AND PERMUTATION

(71) Applicant: International Business Machines Corporation, Armonk, NY (US)

(72) Inventors: Subhankar PAL, White Plains, NY (US); Alper BUYUKTOSUNOGLU, White Plains, NY (US); Ehud AHARONI, Kfar Saba (IL); Nir DRUCKER, Zichron Yaakov (IL); Omri SOCEANU, Haifa (IL); Hayim SHAUL, Kfar Saba (IL); Kanthi SARPATWAR, Elmsford, NY (US); Roman VACULIN, Larchmont, NY (US); Moran BARUCH, Petah Tikva (IL); Pradip BOSE, Yorktown Heights, NY (US)

(21) Appl. No.: 17/857,593

(22) Filed: Jul. 5, 2022

(51) Int. Cl. G06N 3/08; G06N 3/063; H04L 9/00

(52) U.S. Cl. CPC G06N 3/082; G06N 3/063; H04L 9/008

(57) ABSTRACT

An example system includes a processor to prune a machine learning model based on an importance of neurons or weights. The processor is to further permute and pack remaining neurons or weights of the pruned machine learning model to reduce an amount of ciphertext computation under a selected constraint.

### BACKGROUND

The present techniques relate to machine learning models. More specifically, the techniques relate to the execution of machine learning models under homomorphic encryption.

Homomorphic encryption (HE) allows performing operations on encrypted data. Such a cryptosystem may be used, for example, in a client-server scenario where the client desires the server to perform a function f(x). The client can provide x and the function f can be obtained from a different source. HE enables the server to homomorphically compute a function f(x) without learning about the particular value of variable x. The client may then use a private key to decrypt a result encrypted using a corresponding public key. In some schemes, multiple clients may provide multiple keys. For example, in multi-key fully homomorphic encryption (FHE) schemes, every client may have its own private key and provide an associated public key to the server to use to encrypt results.

HE operations may be performed using a single instruction multiple data (SIMD) paradigm in which a message is split into an array of values called slots. A single HE operation is applied to all these slots at once. In particular, a single ciphertext encrypts a fixed size vector, and the homomorphic operations on the ciphertext are performed slot-wise on the elements of the plaintext vector. In the CKKS HE scheme, for instance, up to thousands of encrypted values are stored in a single encrypted message and processed at once. To utilize the SIMD feature, more than one input element may be packed and encrypted in every ciphertext. The packing method may thus dramatically affect the latency, throughput, communication costs, and memory requirements. Thus, the method of packing, or grouping, these values into the encrypted message may be used to improve performance. For example, a naïve way of packing a plaintext matrix may be to pack in a row-major order until all slots of a given ciphertext are “full”, then to create a new ciphertext and repeat. HELayers is an example software development kit (SDK) that automates the packing process for data scientists. In particular, HELayers uses a special packing technique called tile tensors. Tile tensors are data structures that pack tensors in fixed-size chunks, called tiles. For example, tensors may be vectors or matrices. Having a fixed size, this tile tensor data structure fits naturally with HE as each tile can be encrypted into a single ciphertext where the different elements of the each tile are mapped into different slots of its ciphertext. In addition, tensors may also be used to implement various layers of neural network. For example, one solution employs tensors of 5-dimensions denoted as C, X, Y, F, B, where C is the channel dimension encoding the channels of the input; X,Y are the width and height dimensions of the image; F is the filter dimension encoding the different filters of each layer and B is the batch dimension encoding the different images to classify. In addition, the same tensor can be covered by tiles of different shapes of the same size. For example, a matrix can be naively covered by column-vectors or by row-vectors, but the matrix can also be covered by two-dimensional tiles, as long as the number of elements in the tile matches the number of slots in the ciphertext. In addition, tile tensors allow other manipulations such as duplicating elements along one or more dimensions. Some frameworks allow to easily switch between one tile shape to another and also to easily set the amount of duplication along each dimension. Hereinafter, we use tile-shape to include this amount of duplication along each dimension. Different tile-shapes may lead to different performance. For example, one tile shape may require more memory but be optimal in running time, while another shape may be optimal in memory but take more time to run. To find the best shape supported by their system for a given objective, some methods use an optimizer that scans the shape-configuration space and reports the best detected shape. In the context of pruning, packing the neurons and weights of a neural network into tiles raises a problem: pruning can be done only in the resolution of an entire tile (i.e. a ciphertext) and not of a single neuron or weight.

FHE operations may be significantly more expensive compared to their plaintext counterparts. For example, FHE operations may be anywhere from three to five orders of magnitude more computationally intensive than operations performed on plaintext counterparts. One optimization used in the plaintext neural network domain is the use of pruning through operation elimination. Pruning improves the latency by reducing the number of operations that must be performed, and also curbs overfitting and thus improves the accuracy of a deployed network. Pruning a network introduces zeros in the weights and/or activations, so that the computations involving these values may be skipped. Thus, pruning reduces the latency and energy for inference execution. For example, a simple weight-pruning scheme may remove all weights with values less than a certain threshold. Consequently, this reduces the number of operations that need to be formed during inference. While pruning a model that is complex generally results in improving the test accuracy through reduction in variance, oversimplification can lead to underfitting and thus a drop in accuracy. Some pruning techniques may allow for removal of a large fraction of weights under a small accuracy degradation. In addition, re-training the network with the pruning in place may alleviate accuracy loss because training reduces the error output at each neuron.

However, one challenge with pruning in the context of HE-enabled inference is that the latency or energy savings due to reduction in the number of operations does not necessarily scale with or the degree of pruning. For example, the latency or energy savings may not necessarily scale with the number of weights removed. Instead, the actual operation reduction may be also dependent on the method of packing. This may be because the zeroes introduced during pruning may be a packed together with other non-zero values into the same ciphertext message, in which case the entire ciphertext must be retained as-is and the number of operations that will be performed on this ciphertext remains unchanged. Thus, all the packed values in a ciphertext message may have to be zeroes in order to prune the entire message and reap the latency and energy benefits. One solution is to prune in groups that match the shape of the tiles encoded into the ciphertext messages. However, this pruning method may lead to deletion of important weights that can consequently cause a significant drop in accuracy at inference. Moreover, these pruning methods may not guarantee the satisfaction of optimality constraints involving latency, energy, and accuracy.

### SUMMARY

According to an embodiment described herein, a system can include processor to prune a machine learning model based on an importance of neurons or weights. The processor can also further permute and pack remaining neurons or weights of the pruned machine learning model to reduce an amount of ciphertext computation under a selected constraint. Therefore, the processor can enable a pruning-aware packing for machine learning models that improves performance at inference. Preferably, the processor is to prune and pack in tandem. In this embodiment, the pruning may be better able to improve the efficiency of the packing. Optionally, the importance is based on the criticality of the neurons. In this embodiment, neurons that are not important to the accuracy of the model at inference may be pruned to improve efficiency. Optionally, the importance is based on values of the weights. In this embodiment, weights that are not important to the model accuracy may be flagged and thus able to be ignored during inference. Optionally, the selected constraint comprises an inference accuracy constraint. In this embodiment, a specific accuracy can be ensured during inference. Optionally, the selected constraint comprises a memory constraint. In this embodiment, a specific memory usage can be ensured during inference. Optionally, the selected constraint comprises a latency constraint. In this embodiment, a specific latency can be ensured during inference. Preferably, pruning the machine learning model comprises eliminating an operation from the machine learning model. In this embodiment, the efficiency of the machine learning model at inference may be improved. Preferably, the ciphertext computation comprises an execution of a homomorphically encrypted inference of the pruned, permuted, and packed machine learning model. In this embodiment, the homomorphically encrypted inference may have improved accuracy and performance.

According to another embodiment described herein, a method can include pruning, via a processor, a machine learning model based on an importance of neurons or weights. The method can further include permuting and packing, via the processor, remaining neurons or weights of the pruned machine learning model to reduce an amount of ciphertext computation under a selected constraint. Thus, the method can enable a pruning-aware packing for machine learning models that improves performance at inference. Optionally, the method can also include executing a homomorphically encrypted inference using the pruned, permuted, and packed machine learning model. In this embodiment, the homomorphically encrypted inference may have improved accuracy and performance. Optionally, pruning the machine learning model comprises pruning a weight of the machine learning model by setting weights with values that do not exceed a threshold to zero. In this embodiment, the weights may be flagged and ignored during inference. Optionally, pruning the machine learning model comprises pruning a neuron of the machine learning models. In this embodiment, the neuron may be removed and not used during training and inference. Optionally, permuting the machine learning model comprises using a balanced clustering. In this embodiment, a maximum number of zero tiles may be discovered more efficiently. Optionally, permuting the machine learning model comprises alternating between permuting rows and columns of weight matrices corresponding to weights between layers of the machine learning model until a convergence is detected. In this embodiment, a maximum number of zero tiles may be discovered. Optionally, the method includes expanding the pruned and permuted machine learning model to un-prune zero values within partially-zero-valued pruned packing shapes. In this embodiment, accuracy lost during pruning may be regained. Optionally, the method includes simulating the pruned and packed machine learning model to obtain a latency score and memory score associated with a plurality of packing shapes and pruning thresholds, wherein the pruned, permuted, and packed machine learning model comprises a pruning threshold and a packing shape that minimizes an objective function based on the selected constraint. In this embodiment, any selected constraint may be used to ensure that the constraint is met during inference.

According to another embodiment described herein, a computer program product for pruning and packing machine learning models can include computer-readable storage medium having program code embodied therewith. The program code executable by a processor to cause the processor to prune a machine learning model based on an importance of neurons or weights. The program code can also cause the processor to permute and pack remaining neurons or weights of the pruned machine learning model to reduce an amount of ciphertext computation under a selected constraint. Thus, the program code can enable a pruning-aware packing for machine learning models that improves performance at inference. Optionally, the program code can also cause the processor to set weights with values that do not exceed a threshold to zero. In this embodiment, the zero weights may flagged and not considered during training and inference. Optionally, the program code can also cause the processor to permute the machine learning model using a heuristic. In this embodiment, zero tiles to be pruned may be more efficiently increased. Optionally, the program code can also cause the processor to also further permute the machine learning model using a balanced clustering. In this embodiment, zero tiles may be more efficiently discovered. Optionally, the program code can also cause the processor to alternate between permuting rows and columns of weight matrices corresponding to weights between layers of the machine learning model until a convergence is detected. In this embodiment, a maximum number of zero tiles may be discovered. Optionally, the program code can also cause the processor to retrain the pruned machine learning model and execute the pruned machine learning model to obtain an accuracy score for the pruned machine learning model associated with a particular pruning threshold. In this embodiment, the accuracy score can be used to select a best combination of pruning, permutation, and packing. Optionally, the program code can also cause the processor to simulate the pruned and packed machine learning model to obtain a latency score and memory score associated with a plurality of packing shapes and pruning thresholds, wherein the pruned, permuted, and packed machine learning model comprises a pruning threshold and a packing shape that minimizes an objective function based on the selected constraint. In this embodiment, the latency score and memory score may be used by an objective function calculator to select a best combination of pruning, permutation, and packing. Optionally, the program code can also cause the processor to execute a homomorphically encrypted inference using the pruned, permuted, and packed machine learning model. In this embodiment, the homomorphically encrypted inference may perform more efficiently and accurately.

### BRIEF DESCRIPTION OF THE SEVERAL VIEWS OF THE DRAWINGS

FIG. 1 is a block diagram of an example system for pruning, permuting, and packing machine learning models;

FIG. 2 is a block diagram of an example system for generating encrypted results based on encrypted data using a machine learning model packed using pruning and permutation;

FIG. 3A is a process flow diagram of an example process that can select a combination of network packing, pruning, and permutation based on an objective function;

FIG. 3B is a process flow diagram of an example process that can select a combination of network packing, pruning, permutation, and expansion based on an objective function;

FIG. 4 is a diagram illustrating an example process of weight matrix pruning, permutation, and packing;

FIG. 5 is a diagram illustrating an example process of permutation using a balanced variant of k-means;

FIG. 6 is a diagram illustrating an example process for permutation of weights for a multi-layered neural network;

FIG. 7 is a diagram illustrating an example process of neuron pruning with permutation;

FIG. 8 is a diagram illustrating an example process of weight pruning with permutation;

FIG. 9 is a process flow diagram of an example method that can pack, prune, and permute machine learning models under selected constraints;

FIG. 10 is a process flow diagram of an example method that can select a combination of network packing, pruning, and permutation based on an objective function;

FIG. 11 is a process flow diagram of an example method that can generate encrypted results based on encrypted data using a machine learning model packed using pruning and permutation;

FIG. 12 is a block diagram of an example computing device that can pack, prune, and permute machine learning models under selected constraints;

FIG. 13 is a diagram of an example cloud computing environment according to embodiments described herein;

FIG. 14 is a diagram of an example abstraction model layers according to embodiments described herein;

FIG. 15 is an example tangible, non-transitory computer-readable medium that can pack, prune, and permute machine learning models under selected constraints;

FIG. 16 is a diagram illustrating an example process of weight pruning and permutation with an example expansion; and

FIG. 17 is a diagram illustrating an example set of different combinations of pruning, permutation, expansion, and packing, according to embodiments described herein.

### DETAILED DESCRIPTION

According to embodiments of the present disclosure, system includes a processor to prune a machine learning model based on an importance of neurons and weights. The processor is to further permute and pack remaining neurons or weights of the pruned machine learning model to reduce an amount of ciphertext computation under a selected constraint. Thus, embodiments of the present disclosure provide method of pruning-aware packing for machine learning model inference under homomorphic encryption (HE) that reaps the maximum performance benefits from the pruning step without minimum drop in accuracy. In particular, a major improvement in efficiency was noted especially for larger tiles when experimenting on the autoencoder neural network. In particular, an example iterative k-means permutation algorithm increased the number of tiles with only zero elements from 40% to 50%, 20% to 40%, and 8% to 40% for tile sizes of 4×4, 8×8, and 16×16.

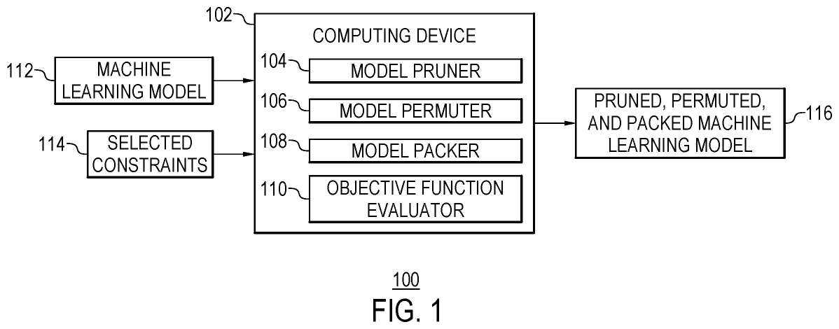

With reference now to FIG. 1, a block diagram shows an example system for pruning, permuting, and packing machine learning models. The example system is generally referred to by the reference number 100. FIG. 1 includes a computing device 102. For example, the computing device 102 may be a server. In some examples, the computing device 102 may be a node of a cloud computing service. The computing device 102 include a network pruner 104, a network permuter 106, a network packer 108, and an objective function evaluator 110. The computing device 102 is shown receiving a machine learning model 112. For example, the machine learning model 112 may be any suitable machine learning model trained to perform HE operations. In various examples, the machine learning model 112 may be a neural network. For example, the machine learning model 112 may be a convolutional neural network (CNN), an autoencoder, or any other suitable machine learning model. In various examples, the machine learning model 112 may be encrypted or unencrypted. The system 100 also include selected constraints 114 shown being received by the computing device 102. For example, the selected constraints 114 may be any suitable constraints, such as an inference accuracy constraint, a memory constraint, a latency constraint, amortized latency, power constraint, energy constraint, or any combination thereof. The system also includes a pruned, permuted, and packed machine learning model 116, shown being output by the computing device 102.

In the example of FIG. 1, the computing device 102 receives a machine learning model 112 and selected constraints 114 and outputs a pruned, permuted, and packed machine learning model 116 that meets the selected constraints 114. In various examples, the machine learning model 112 may be encrypted or unencrypted. For example, the machine learning model 112 may have been encrypted after being trained on proprietary information. Therefore, the weights of the machine learning model 112 may be deployed to the untrusted computing device 102 in an encrypted format. The computing device 102 may thus learn about the shape of the machine learning model 112, such as the number of layers and number of parameters for each layer, but may know nothing about the values of any of the parameters. In some examples, the activation inputs from the client may also be encrypted under HE. In addition, if some operations were eliminated, the computing device 102 may also be allowed to learn which operations were eliminated. In this manner, the underlying propriety information may be kept secret by keeping the model secret.

In some examples, the machine learning model 112 may be unencrypted. For example, the machine learning model 112 may have been trained on publicly available data that is not subject to any restrictions and thus may not have to be kept secret. In other example, the machine learning model 112 may be encrypted. For example, the machine learning model 112 may have been trained on data that is subject to restrictions on accessibility.

Still referring to FIG. 1, the network pruner 104 of the computing device 102 may prune the machine learning model 112. For example, the network pruner 104 may prune the machine learning model 112 using any number or type of suitable pruning thresholds or parameters. In various examples, the threshold may be a value of the weight that has a bigger L1-norm compared to some fixed percentage of other weights, referred to herein as an L1-based pruning. In some examples, any other suitable pruning parameters may be received. For example, the pruning parameters may include whether to prune weights or neurons, and whether to use a random pruning, a global pruning, or a local pruning. For example, random pruning may randomly prune neurons or randomly set model weights to zero. In global pruning, all layers are pruned at once. In local, local pruning, every layer is pruned according to the other parameters. When using random pruning, these parameters may not have an effect. However, the parameters may have a strong effect when considering, for example, an L1-based pruning. For example, if the processor prunes 50% of the network, then only the initial layers may be pruned. In various examples, any of six different pruning configurations from the combinations of these parameters {W, L}×{R, L1}×{W, N}, where G/R/{W, N} is the same as L/R/{W, N}, and W refers to pruning weights, N refers to pruning neurons, G refers to a global pruning method, L refers to a local pruning method, and L1 refers to an L1-based pruning. In some examples, the network pruner 104 may use a packing-based pruning configuration, also referred to herein as prune^{pack}. For example, the network pruner 104 may first choose a packing shape size. In the example of tile tensors, the packing shape size may be a tile size. In various examples, a tile size may be 2×2, 4×8, or 8×8. The network pruner 104 may then split every matrix into tiles. For every tile, the network pruner 104 can compute the minimum, maximum, or average of its values and prune tiles with the lowest results.

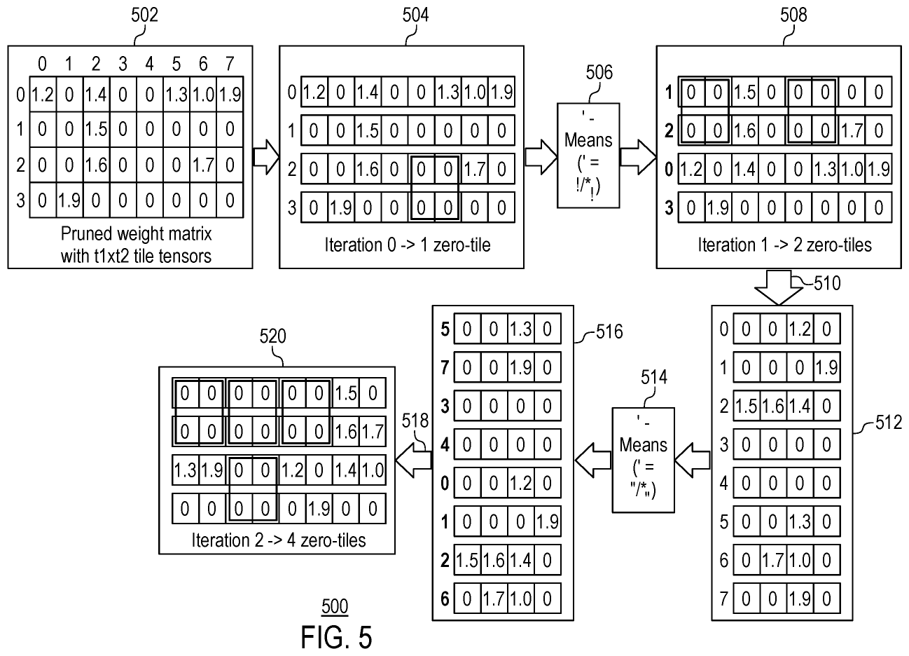

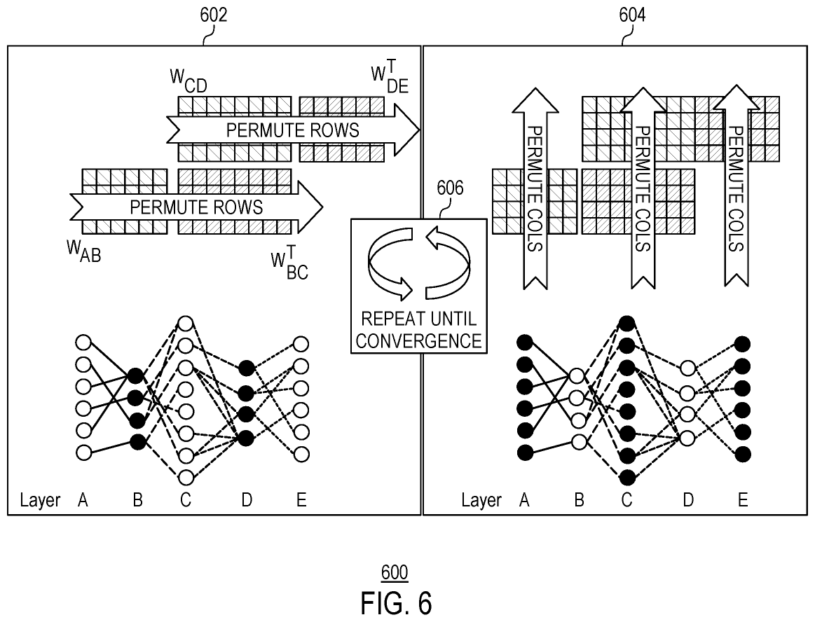

The network permuter 106 can permute the machine learning model 112 after the machine learning model is pruned. For example, the network permute 106 can permute the machine learning model 112 using any suitable heuristic, such as a balanced clustering heuristic. In some examples, the network permuter 106 can use a k-means clustering heuristic, as described in greater detail in FIG. 5. In some examples, the network permuter 106 can permute rows and columns of weight matrices corresponding to weights between layers of the machine learning model in an alternating manner, such as described in greater detail with respect to FIG. 6.

The network packer 108 can pack the pruned and permuted machine learning model using any suitable packing shape or size. For example, the network packer 108 can pack the pruned and permuted machine learning model using a variety of different packing shapes and sizes.

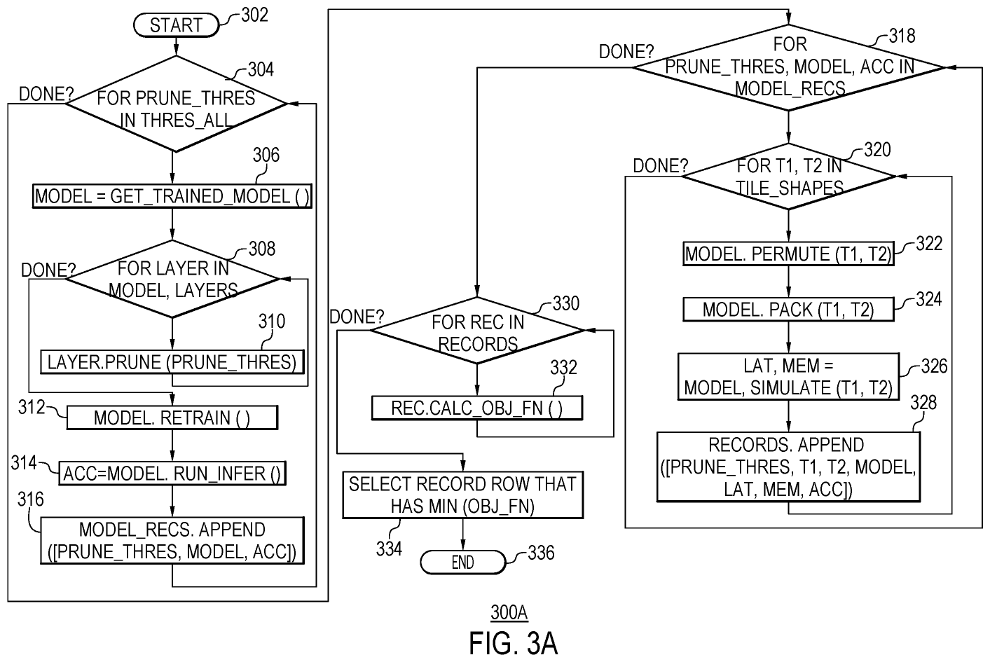

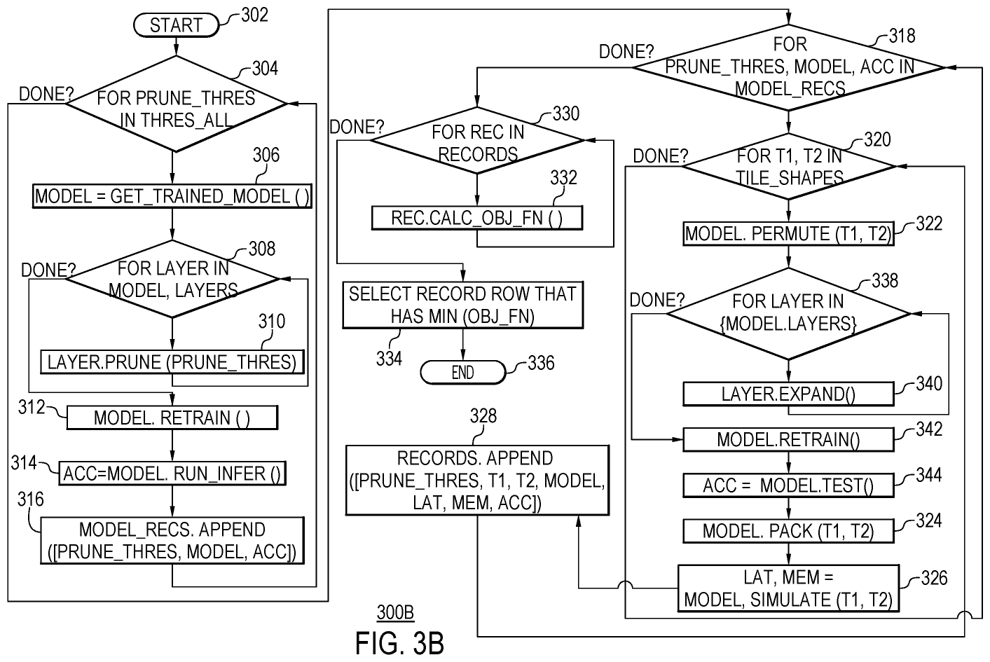

In some examples, the network pruner 104, the network permuter 106, and the network packer 108 can generate a number of pruned, permuted, and packed machine learning models. In various examples, the objective function evaluator 110 can evaluate each combination of different pruning, permutation, and packing based on an objective function and the one or more selected constraints 114. An example algorithm for calculating an example objective function is described with respect to FIG. 3.

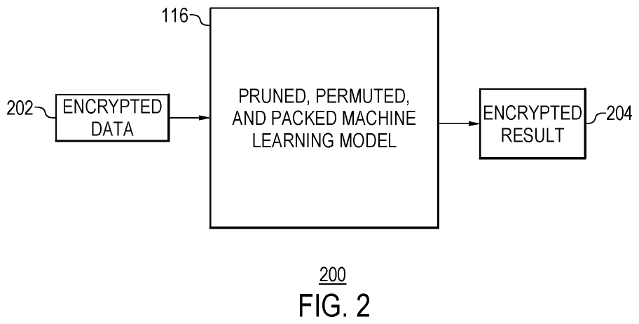

In various examples, the resulting pruned, permuted, and packed machine learning model 116 may be output and used for inference in an HE environment. An example pruned, permuted, and packed machine learning model 116 being used in this manner is described with respect to FIG. 2.

As one specific technical example, the HeLayers packing solution may be used with CKKS SEAL implementation targeting 128 bit security. For training, a cluster of server-class machines may be equipped with GPUs. The training may use PyTorch version 1.11.0 accelerated with CUDA version 11.6. The network architecture used may be an autoencoder network architecture, in which every fully connected (FC) layer is followed by a square activation layer. For example, square activations may be used instead of rectified linear unit (ReLU) activations to support non-interactive solutions that required HE-friendly networks. In various examples, finer activations, such as higher degree activations or trainable activations may additionally or alternatively be used to achieve better results. As one example, the autoencoder network may include an FC with 32 neurons or 64 neurons. In some examples, the autoencoder network may include multiple FC layers, such as three FC layers with sizes of 64, 32, and 64 neurons. The autoencoder network may be trained on the MNIST dataset, first released in 1998, which has 60,000 images of 28×28×1=768 pixels. Therefore, the autoencoder's input size and the output size of the decoder may be 768. In some examples, the decoder may be fused to the encoder as an additional FC layer of the relevant size and trained together. The number of training and retraining epochs may be set to {20,10},{30.20} or any other suitable values. Batches of ten samples may be used, and the learning rate of the Adam optimizer may be set to 1e-3. In various examples, the loss function used may be any suitable loss function, such as mean squared error (MSE) between the input image and reconstructed image. In this example, HeLayers uses data structures called CtileTensor and PtileTensor to hold tile tensors of encrypted and unencrypted data, respectively. These have an API called encode to encode (pack) the data before encrypting it. Therefore, in some examples, HeLayers may be adapted to automatically identify zero tiles by modifying the different encoding functions to test for every tile whether all of its elements are zero or not. In case a tile contains only zeros, the processor may not allocate it and instead included a new flag to indicate that this is a zero tile. In various examples, when considering binary addition and multiplication operations that receive two inputs, if only one of the inputs has a set flag, then the addition function may be modified to return the other object and the multiplication function may be modified to return a new null tile with this flag set. In the case that both inputs are zero, then the returned element may be a null tile.

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional computing devices, or additional machine learning models, pruned, permuted, and packed machine learning models, or additional processing such as expansion, etc.). For example, the system 100 may additionally include a model expander to reduce neurons or weights including zero values. For example, the model expander may execute an operation that reverses the pruning operation. In particular, the model expander may search for tiles that do not hold only zero values and un-prune the zero elements inside them. The unpruned weight elements may then be trained to improve model accuracy. In this manner, the model expander may regain some of the lost accuracy of the model due to the initial pruning. For example, if a tile is not reduced because it has non-zero elements, then a system at inference cannot ignore the tile. Therefore, the model expander may instead fully utilize its elements to increase the performance of the model at inference.

FIG. 2 is a block diagram shows an example system for generating encrypted results based on encrypted data using a machine learning model packed using pruning and permutation. The example system 200 includes similarly referenced elements from FIG. 2. For example, the system 200 includes a pruned, permuted, and packed machine learning model 116. The pruned, permuted, and packed machine learning model 116 of system 200 is shown receiving encrypted data 202 and outputting an encrypted result 204. For example, the encrypted data 202 may be any information to be classified, such as images. In various examples, the encrypted result 204 may include a classification of the input encrypted data 202. In some examples, the encrypted result 204 may also include a confidence score of the classification.

As previously described, one practical application of HE is for encrypted inference on neural networks running on the cloud. For example, the system 200 may be used for the diagnosis of COVID-19 through classification of X-ray images of patients in a hospital setting, for which the encrypted X-ray images are transmitted securely to the cloud. In this example, the computing device 102 may be a server running a machine learning model that is trained on a different system, using proprietary data that is not made available to the public, and thus the parameters of the network may be encrypted to hide them from the server. The parameters may include weights or biases. In this example, the client can obtain an encrypted classification result 204 from the server without the server learning anything about the images or the network parameter values. The client may then decrypt the encrypted result 204 using a key. For example, the key may correspond to a key used to encrypt the encrypted X-ray images.

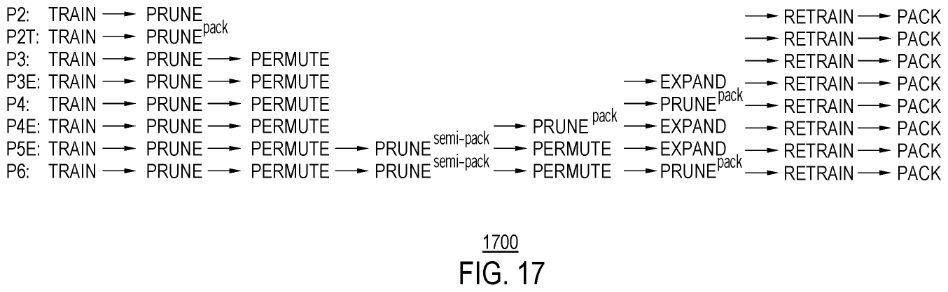

It is to be understood that the block diagram of FIG. 2 is not intended to indicate that the system 200 is to include all of the components shown in FIG. 2. Rather, the system 200 can include fewer or additional components not illustrated in FIG. 2 (e.g., additional data, or additional results, etc.). For example, the pruned, permuted, and packed machine learning model may alternatively be a pruned, permuted, expanded, and packed machine learning model, or a product of any of the combinations of these operations as described in FIG. 17 below.

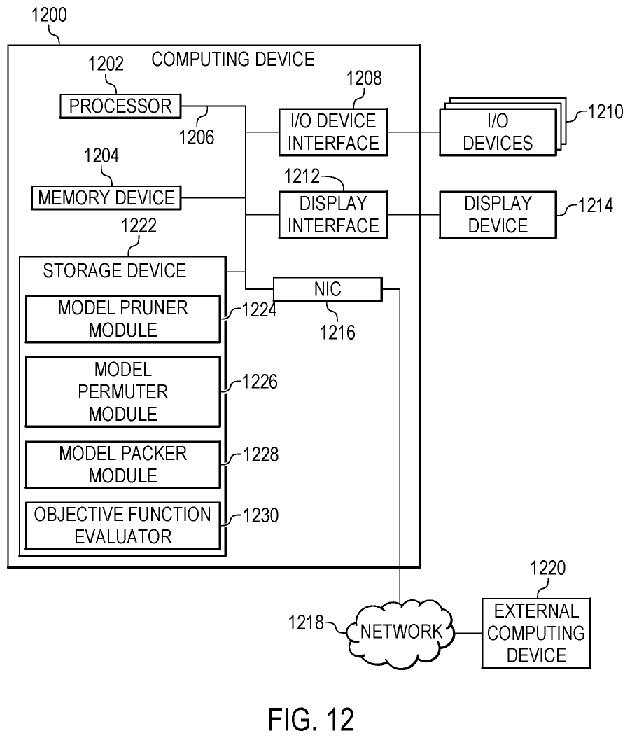

FIG. 3 is a process flow diagram of an example process that can select a combination of network packing, pruning, and permutation based on an objective function. The process 300 can be implemented with any suitable computing device, such as the computing device 1200 of FIG. 12 or the system 100 of FIG. 1. For example, the method described below can be implemented by the computing device 102, the processor 1202, or the processor 1502 of FIGS. 1, 12, and 15.

FIG. 3A illustrates a process of pruning, permuting, and packing a machine learning model for inference on a network with two-dimensional tile tensors and a batch size of 1. In various examples, block 302-336 may be part of a pre-deployment process and performed on a system that has access to plaintext network parameters, since the pruning algorithm generally takes in the values of each parameter as input. In addition, the example of FIG. 3A considers pruning individual weights based on a threshold value. The general goal in the example of FIG. 3A may be to find a value of the pruning threshold (PRUNE_THRES) and a tile tensor shape that optimizes the machine learning model for a given objective function. In various examples, the objective function may be based on any combination of accuracy, latency, memory requirements, energy consumption, among any other suitable selected constraints.

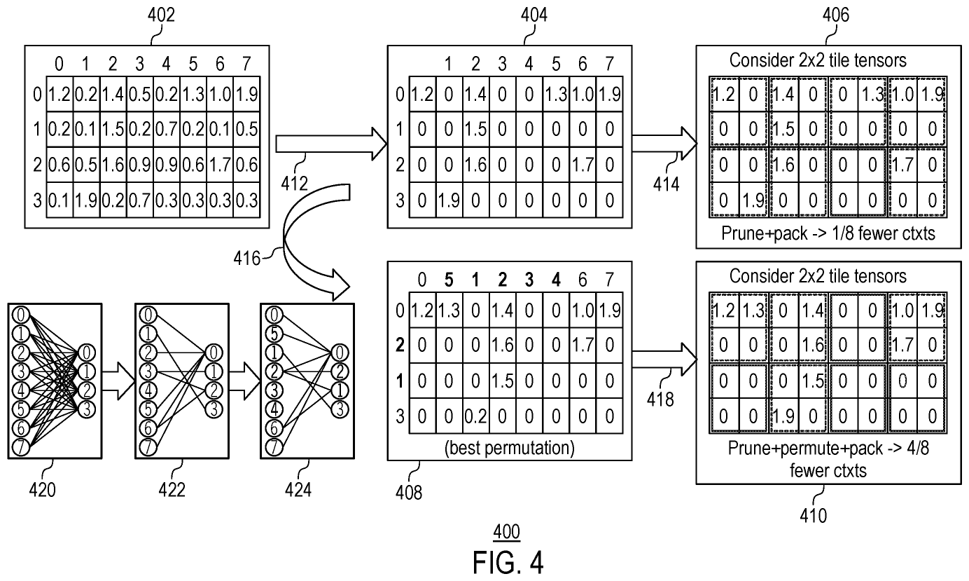

At block 302, the process 300 begins. In various examples, a processor may receive a trained model, a set of pruning thresholds, and a set of different tile shapes. For example, the pruning threshold may be a value of “1” as in the examples of FIGS. 4 and 5 below, among other suitable values. In various examples, the pruning threshold may be an L1-based pruning threshold.

At decision diamond 304, the processor determines whether each pruning threshold PRUNE_THRES in the set of received pruning thresholds THRES_ALL has been processed. If all the pruning thresholds THRES_ALL have been processed, then the process may continue at decision diamond 318. If all the pruning thresholds THRES_ALL have not been processed, then the process may continue at block 306.

At block 306, the processor sets the received trained model as a model to be processed. In some examples, the processor may process multiple models and may thus retrieve one of a set of models provided to be pruned, permuted, and packed.

At decision diamond 308, the processor determines whether all the layers in the model have been processed. If all the layers in a model have been processed, then the process may continue at block 312. If all the layers in a model have not been processed, then the process may continue at block 310.

At block 310, the processor prunes the selected layer of the model based on the selected pruning threshold PRUN_THRES. For example, the processor may prune a machine learning model based on the threshold value. In various examples, the processor may use weight-pruning, neuron-pruning, or a combination thereof.

At block 312, the processor retrains the pruned model. For example, the processor may retrain the pruned network to recuperate some of the resulting accuracy loss from pruning.

At block 314, the processor executes the trained pruned model to obtain an accuracy score for the trained pruned model. For example, an updated accuracy score may be obtained by running inference on a test set on the pruned and retrained machine learning model.

At block 316, the processor appends the combination of pruning threshold PRUNE_THRES, model, and associated accuracy score for the model pruned using the pruning threshold PRUNE_THRES to a set of model records MODEL_RECS. For example, set of model records MODEL_RECS may be stored in a file.

At decision diamond 318, the processor determines whether each combination of pruning threshold PRUNE_THRES, model, and associated accuracy score for the model pruned using the pruning threshold PRUNE_THRES has been processed with permutations. If not, then the process may continue at decision diamond 320. If so, then the process may continue at decision diamond 330.

At decision diamond 320, the processor determines whether all different tile sizes and tile shapes received in TILE_SHAPES has been processed for a particular combination of pruning threshold PRUNE_THRES, model, and associated accuracy score for the model pruned using the pruning threshold PRUNE_THRES. If so, then the process may continue with additional combinations at decision diamond 318. If not, then the process may continue at block 322 with additional permutations. For example, the set TILE_SHAPES may be an independent set of tuples of integers. As one example, the value of TILE_SHAPES may be 1(2,2), (3,3)} for a set of two 2D tiles of length=2, width=2 and length=3, width=3, respectively.

At block 322, the processor permutes the model using a combination of tile shapes T1 and T2. For example, the processor may permute the model using any suitable heuristic, such as an iterative clustering algorithm. In some examples, the heuristic may be a balanced clustering heuristic. In some examples, the processor may use a balanced k-means clustering technique, as described in FIG. 5.

At block 324, the processor packs the permuted model. For example, the processor can pack the weight and activation tensors into T1×T2 tiles. In various examples, the processor may also discard zero tiles.

At block 326, the processor simulates the packed permuted model to generate associated latency and memory values for the packed permuted model. For example, these latency and memory scores may be calculated in response to receiving selected latency and memory constraints from a client. Thus, the processor may simulate the network to obtain an estimate of latency and memory requirements of the packed permuted model.

At block 328, the processor appends the combination of pruning threshold PRUNE_THRES, model, and associated accuracy score for the model pruned using the pruning threshold PRUNE_THRES, and latency and memory scores for the model when packed and permuted with tile shapes T1 and T2 to a records file. The records file may thus include rows corresponding to all combinations of different pruning thresholds, permutations, and tile tensor shapes.

At decision diamond 330, the processor determines whether each of the records in the records file has been processed to generate an objective function score. If not, then the process may continue at block 332 to process additional records. If so, then the process may continue at block 334.

At block 332, the processor calculates an objective function score for each of the records in the records file. For example, the objective function score may depend on the objective function and various selected optimization constraints. In the example of FIG. 3, these optimization constraints include accuracy, latency, and memory constraints.

At block 334, the processor selects a record row from the records file associated with a lowest objective function score as calculated at block 332. For example, a best record row may be picked depending upon the objective function and optimization constraints.

At block 336, the process ends. In some examples, the processor may output a model that is pruned, permuted, and packed using the selected record row of block 334.

The process flow diagram of FIG. 3A is not intended to indicate that the operations of the process 300A are to be executed in any particular order, or that all of the operations of the process 300A are to be included in every case. For example, although shown using tile tensor grouping for illustration, any other suitable group may alternatively be used. In addition, the process 300A of FIG. 3A considers pruning individual weights based on a threshold value. However, other pruning methods may be used, such as pruning groups of weights, which would get packed into the same encrypted message together, as well as techniques in prior art such as pruning based on activation criticality, dynamic pruning and splicing of weights, among other suitable pruning techniques. Additionally, the process 300A can include any suitable number of additional operations. In some examples, although the process 300A uses an exhaustive search strategy to find the optimal point, however a local search strategy may alternatively be used. For example, an exhaustive search to find the permuted matrix with the maximum number of zero tiles may cost O(M!N!), which may be prohibitive even for moderate-sized weights. Therefore, in some embodiments, the process 300A can instead permute the rows and columns based on heuristics to make the problem tractable. For example, the method 300A can use the example k-means heuristic described in FIG. 5. In some examples, the method 300A may further include an expansion of partially zero valued tiles to further increase accuracy and efficiency, as described in FIG. 3B.

FIG. 3B is a process flow diagram of an example process that can select a combination of network packing, pruning, permutation, and expansion based on an objective function. The process 300B can be implemented with any suitable computing device, such as the computing device 1200 of FIG. 12 or the system 100 of FIG. 1. For example, the method described below can be implemented by the computing device 102, the processor 1202, or the processor 1502 of FIGS. 1, 12, and 15.

The process 300B of FIG. 3B includes similarly referenced elements of FIG. 3A. In addition, at decision diamond 338, the processor determines whether all layers in a model have been further processed. If not the process continues at block 340. If so, then the process 300B may continue at block 342.

At block 340, the processor executes an expand operation. For example, the expand operation may un-prune any partially zero tiles in the layer of the machine learning model.

At block 342, the processor retrains the model. For example, the machine learning model may be retrained with the un-pruned values to improve accuracy of the resulting retrained model.

At block 344, the processor executes the machine learning model on a test set of data in order to generate an updated accuracy score for the retrained model. For example, the updated accuracy score may be higher due to the additional weights made available during training. In various examples, the updated accuracy score may replace the accuracy score in the records file and used instead of the previous accuracy score when calculating the objective function at block 332.

The process flow diagram of FIG. 3B is not intended to indicate that the operations of the process 300B are to be executed in any particular order, or that all of the operations of the process 300B are to be included in every case. For example, although the example of FIG. 3B is showing the example P3E of FIG. 17, in some examples, FIG. 3B may include a prune-based packing such as in P4E of FIG. 17, or prune-based semi-packing as in P5E of FIG. 17.

FIG. 4 is a diagram illustrating an example process of weight matrix pruning, permutation, and packing. The example process 400 can be executed by any suitable processor, such as a processor of the computing device 102 the processor 1202, or the processor 1502 of FIGS. 1, 12, and 15.

The process 400 of FIG. 4 includes an initial weight matrix 402. As one example, the numbered rows of the weight matrix 402 correspond to a first layer of a neural network and the numbered columns of the weight matrix response to a second layer of the neural network. FIG. 4 shows a simple example of a 4×8 weight matrix and packing shapes of 2×2 tiles. As shown in FIG. 4, the values of the weight matrix range from 0.1 to 1.9 and correspond to weights between neurons of the two layers. The process 400 includes a pruned weight matrix 404, in which values of less than 1.0 have been pruned from the weight matrix 402.

The process 400 further shows a first pruned and packed weight matrix 406, in which one of eight tiles is a zero-tile containing all zero values. In FIG. 4, this zero-valued tile tensor that can be discarded is shown in bolded solid outlining. The other non-zero tiles are indicated using dashed outlining. The process 400 further includes a pruned and permuted weight matrix 408, on which a best permutation has been applied. For example, any number of different permutations may have been performed and the best permutation selected and applied based on maximization of zero-tiles. In some examples, a best permutation may be chosen using an objective function as described herein. The process 400 further includes a pruned, permuted, and packed weight matrix 410, in which four of the eight tiles are zero-tiles, indicated by bold outlining. The pruning 412 of weight matrix 402 is indicated by a first arrow. The packing 414 of the pruned weight matrix 404 is indicated by a second arrow. The permutation 416 of the pruned weight matrix 404 is indicated by a third arrow. The packing 418 of the pruned and permuted weight matrix 408 is indicated by a fourth arrow. FIG. 4 further shows a neural network 420 corresponding to the weight matrix 402, a pruned neural network 422 with pruned weights corresponding to the zeros of the pruned weight matrix 402, and a pruned and permuted neural network 424 having an order of rows and columns corresponding to the pruned and permuted weight matrix 408.

In the example of FIG. 4, an example pruning threshold applied has a value of 1, and thus weights with values <1.0 have been zeroed-out in pruned weight matrix 404. As shown in block 406 FIG. 4, if the weight tensors are packed as-is at the stage shown in block 404, only one of the 8 tile tensors contains all zeros and can thus be discarded by a processor. The remaining seven tile tensors in block 406 contain a mix of non-zeros in addition to zeros. These tile tensors thus cannot be discarded. To improve the number of zero tensors that can be discarded, the processor may therefore permute the rows and columns of the tensor before packing the permuted tile tensors. For example, the processor may rearrange the rows and columns such that zero values are grouped together as much as possible. In various examples, the processor may perform this regrouping using a permutation procedure, resulting a best permutation 408. For example, any suitable permutation procedure may be used. In some examples, the permutation procedure used may be the alternating permutation process of permuting rows and columns of weight matrices described in FIG. 5.

By permuting the rows and columns according to a balanced k-means permutation algorithm, the processor has increased the number of zero tiles to a maximum of four as shown in block 410. For example, the processor may have used the balanced k-means permutation described in FIG. 5 below. This increase zero tiles directly translates to reduction in execution time of the network when inference is performed. Moreover, the permutation of rows and columns of the weight matrix 404 is equivalent to shuffling the neurons within one or more layers of the weight matrix 404, and thus does not affect the functionality of the overall neural network.

It is to be understood that the block diagram of FIG. 4 is not intended to indicate that the process 400 is to include all of the components shown in FIG. 4. Rather, the process 400 can include fewer or additional components not illustrated in FIG. 4 (e.g., additional layers, neurons, weights, tile shapes, dimensions, or additional permutations, etc.). In various examples, higher-dimensional tile tensors may be alternatively used, such as 2×2×256 tile tensors. In some examples, a batch dimension may also be used. For example, the batch dimension may include the use of subsets of the original weight matrix for the purpose of pruning. For example, given a ciphertext that encrypts a vector of 1024 elements, then block 410 may have to prune all the 1024 packed elements, which may reduce accuracy. Alternatively, the processor can instead assume an inference system that performs inference over a batch of 256 samples at once. In that case, tile tensors will allocate 2×2 slots per sample in every ciphertext. Therefore, the processor may only need to prune 2×2 tiles from the weight matrix, which may be much more feasible.

FIG. 5 is a diagram illustrating an example process of permutation using a balanced variant of k-means. The example process 500 can be executed by any suitable processor, such as a processor of the computing device 102 the processor 1202, or the processor 1502 of FIGS. 1, 12, and 15.

In various examples, an example heuristic for permutation is based on a k-means clustering technique. More specifically, the example of FIG. 5 illustrates the use of a balanced k-means. The process 500 of FIG. 5 includes a first weight matrix 502. For example, the first weight matrix 502 may be a pruned weight matrix with T1×T2 tile tensors. A set of numbers for the rows and a set of numbers for the columns is used to indicate an initial ordering of the rows and columns, respectively. At iteration 0 504, the initial weight matrix 502 only includes one zero-tiled tile tensor indicated in bold lining, in which the values of the tile tensor are all zero.

In various examples, the rows of the pruned weight matrix 502 may be considered as vectors and a first iteration of k-means 506 may be applied to produce a new weight matrix 508 with the rows permuted to increase the number of zero-tiles. In particular, the new weight matrix 508 includes two zero-tiles indicated by bold lining. In addition, the new order of rows is indicated by bold numbering. In particular, row 0 has been shifted down two places to be placed between rows 2 and 3.

In the example process 500 of FIG. 5, the new matrix 508 is then transposed 510 to generate a transposed matrix 512. At arrow 514, the processor may then apply a second iteration of k-means to the transposed matrix 512 to generate a second new matrix 516. The second new matrix 516 shows a new ordering of the original columns as indicated in bold numbering.

At arrow 518, the processor may transpose the second new matrix 516 to generate a transposed second new matrix 520. The transposed second new matrix 520 includes four zero-tiles, as indicated by bold outlines.

In various examples, the process 500 is repeated until convergence. For example, convergence may be reached when a row and column permutation do not result in any additional zero-tiles. As one example, if the processor prunes 400 elements and the tile size is 2×2=4 elements, and the processor detects 100 zero tiles, then convergence may be assumed. However, alternatively, the processor may stop process 500 after a given threshold. For example, the processor may stop the process 500 after 80% of the elements form zero tiles. In some examples, the distance function used may be a Hamming distance. For example, non-zero cells may be treated as having a value of “1”. In various examples, the number of clusters used by the processor for k-means is equal to the number of tiles along the rows or columns, depending on the iteration being performed. For example, given an M×N matrix and t1×t2 tiles, the number of clusters at iteration i may be equal to ceil(M/t1) [if i is even] and ceil(N/t2) [if i is odd]. In this example, for a 8×16 matrix with 4×2 tiles, the number of clusters would therefore be 2, 8, 2, 8, . . . , etc.

It is to be understood that the block diagram of FIG. 5 is not intended to indicate that the system 500 is to include all of the components shown in FIG. 5. Rather, the system 500 can include fewer or additional components not illustrated in FIG. 5 (e.g., additional layers, neurons, weights, tile shapes, or additional types or iterations of permutations, etc.). In various examples, the process 500 may alternative use higher-dimensional tile tensors. For example, the process may use 2×2×256 tile tensors. In various examples, the k-means clustering technique of process 500 may alternatively be replaced with any other suitable balanced clustering techniques. For example, alternative balanced clustering techniques may include agglomerative clustering or graph partitioning techniques, such as the Normalized Cut (Ncut) technique, first described in 1997, that measures total dissimilarity between different groups as well as total similarity within groups in treating image segmentation as a graph partitioning problem. Other clustering techniques with balanced variants that can be used include a Gaussian Mixture Model (GMM) and a Density-Based Spatial Clustering of Applications with Noise (DBSCAN).

FIG. 6 is a diagram illustrating an example process for permutation of weights for a multi-layered neural network. The example process 600 can be implemented with any suitable computing device, such as the computing device 1200 of FIG. 12 or the system 100 of FIG. 1. For example, the process 600 can be implemented by the computing device 102, the processor 1202, or the processor 1502 of FIGS. 1, 12, and 15.

The example process 600 includes a first permutation 602 and a second permutation 604. As indicated by two arrows 606, a processor may repeat the permutations 602 and 604 until convergence.

In various examples, in the case of a single weight matrix for a 2-layered network, the processor can permute the rows and columns independently. However, for a deeper network, such as the neural network shown in FIG. 6, the weights for adjacent layers may also be affected when permuting the rows or columns of a given layer. In the example of FIG. 6, the example neural network includes five layers labeled A, B, C, D, and E. A set of weights depicted as lines between and connecting the various layers A, B, C, D, and E, are labeled W_{AB}, W_{BC}, W_{CD}, and W_{DE}, respectively. In the example of FIG. 6, the transposes of W_{BC} and W_{DE} are labeled as W_{BC}^{T} and W_{DE}^{T}, respectively.

In the example, shuffling the neurons in layer B translates to permuting the rows of the transposed weight matrix W_{BC}^{T}, however this also permutes the rows of the preceding weight matrix W_{AB}. Thus, in various examples, a processor may permute the rows of weight matrix W_{AB} and transposed weight matrix W_{BC}^{T} in tandem, treating them as a concatenated matrix. The processor may similarly permute the rows for weight matrix W_{CD} and transposed weight matrix W_{DE}^{T} in the case of permutations of neurons in layer D. In this manner, the processor may permute one set of layers in block 602.

At block 604, the processor may similarly permute remaining set of layers along columns. For example, the processor can permute layers A, C, and E using the columns of weight matrices W_{AB}, W_{CD} and transposed weight matrices W_{BC}^{T} and W_{DE}^{T}. In block 604, the shuffling of neurons in layer C translates to the processor permuting the columns of the weight matrix W_{CD} and the transposed weight matrix W_{BC}^{T} in tandem. The processor may also similarly separately and simultaneously permute the columns of weight matrix W_{AB} and transposed weight matrix W_{DE}^{T}.

At block 606, the process is repeated. For example, the processor may iterate over blocks 602 and 604 until a convergence is reached. In some examples, convergence may be detected based on a permutation not resulting in any additional zero-tiles. In various examples, convergence may be based on a preset maximum iteration count that addresses oscillatory behavior. For example, if an algorithm oscillates between a permutation with 41 zero tiles and 42 zero tiles, then convergence may be detected after a preset number of oscillations. In some examples, the processor may detect convergence in response to determining that the zero tile counts obtained in the last N iterations has not changed.

It is to be understood that the diagram of FIG. 6 is not intended to indicate that the process 600 is to include all of the components shown in FIG. 6. Rather, the process 600 can include fewer or additional components not illustrated in FIG. 6 (e.g., additional layers, neurons, weights, tile shapes, or additional types or iterations of permutations, etc.).

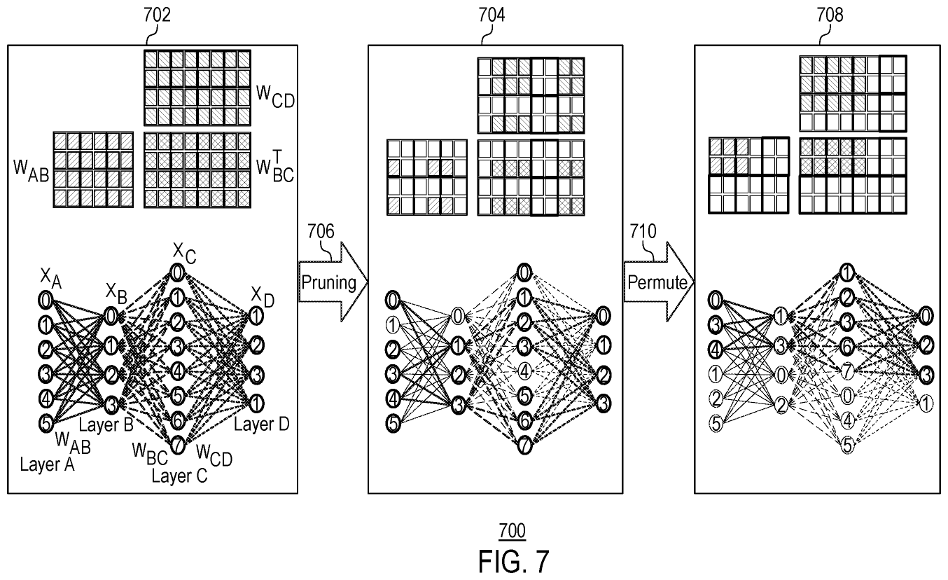

FIG. 7 is a diagram illustrating an example process of neuron pruning with permutation. The example process 700 can be implemented with any suitable computing device, such as the computing device 1200 of FIG. 12 or the system 100 of FIG. 1. For example, the process 700 can be implemented by the computing device 102, the processor 1202, or the processor 1502 of FIGS. 1, 12, and 15.

The example process 700 for neuron pruning of FIG. 7 is illustrated for a 4-layered neural network, with 6, 4, 8 and 4 neurons in each of layers A, B, C, D, respectively. The neurons of layers A, B, C, D may be described as vectors X_{A}, X_{B}, X_{C}, and X_{D}. FIG. 7 also includes a set of associated weight matrices W_{AB}, W_{CD} and transposed weight matrix W_{BC}^{T}. As shown in FIG. 7, the process 700 discovers a re-arranged network such that the packing method can discard the maximum number of encrypted messages that contain only 0s, thus improving the inference latency on this pruned network without affecting functionality, and thus not affecting accuracy of the pruned network at inference. In the neuron-only pruning example shown in FIG. 7, the processor may simply remove the last k empty columns and 1 empty rows of each of the pruned and permuted weight matrices.

At block 702, the original 4-layered neural network contains all of its original weights. At block 704, after pruning 706 indicated by an arrow, a significant portion of the original weights have been removed as indicated by greyed blocks. For example, the pruning 706 may be performed using any suitable pruning technique, such as by a pruning threshold. In the example of FIG. 7, the pruning threshold may be a neuron criticality threshold. However, as indicated by bold blocks, only a total of four of the 2×2 packings contain all zeros and are therefore considered zero-tiles corresponding to neurons that can be discarded.

At block 708, after a permutation 710, the number of zero-tiles has increased to 11 total zero-tiles that can be discarded. By discarding 11 instead of two encrypted messages, the inference latency of the resulting pruned, permuted, and packed network may be significantly improved.

It is to be understood that the diagram of FIG. 7 is not intended to indicate that the process 700 is to include all of the components shown in FIG. 7. Rather, the process 700 can include fewer or additional components not illustrated in FIG. 7 (e.g., additional layers, neurons, weights, tile shapes, or additional types or iterations of permutations, etc.).

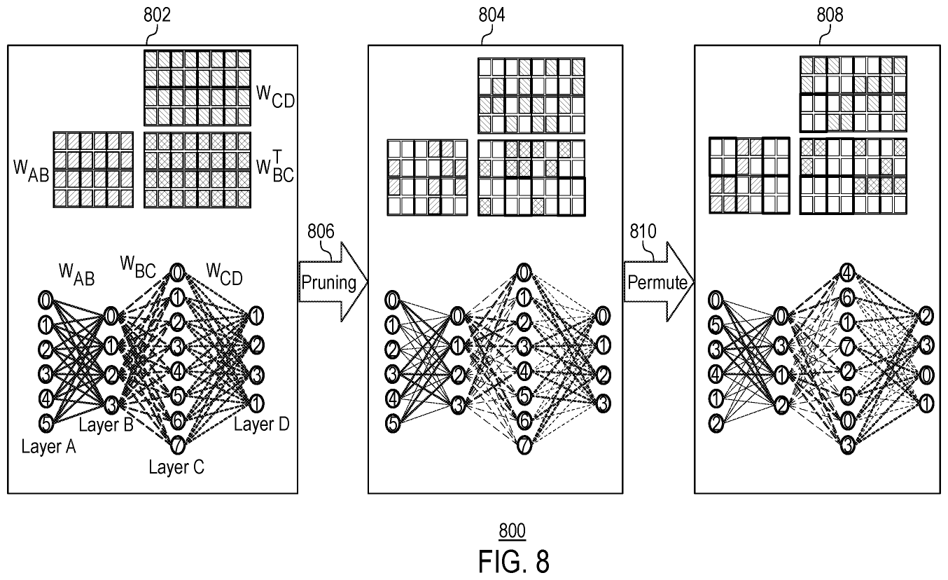

FIG. 8 is a diagram illustrating an example process of weight pruning with permutation. The example process 800 can be implemented with any suitable computing device, such as the computing device 1200 of FIG. 12 or the system 100 of FIG. 1. For example, the process 800 can be implemented by the computing device 102, the processor 1202, or the processor 1502 of FIGS. 1, 12, and 15.

The example process 800 for weight pruning of FIG. 8 is similarly illustrated for a 4-layered neural network, with 6, 4, 8 and 4 neurons in each of layers A, B, C, D, respectively. FIG. 8 also includes a set of associated weight matrices W_{AB}, W_{CD} and transposed weight matrix W_{BC}^{T}. As shown in FIG. 8, the process 800 similarly discovers a re-arranged network such that the packing method can discard the maximum number of encrypted messages that contain only 0s, thus improving the inference latency on this pruned network without affecting functionality, and thus not affecting accuracy of the pruned network at inference.

In the example of FIG. 8, at block 804, the weights corresponding to zero-tiles are discarded via a pruning 806 but the neurons themselves are kept. For example, pruning entire neurons may be too aggressive for certain networks. Therefore, as shown in FIG. 8, a processor may alternatively more conservatively prune only the weights instead. However, in the example of weight pruning, the processor cannot simply drop the last few rows and columns as described in FIG. 7. Instead, in the weight pruning example of FIG. 8, the processor tags each zero tile in block 808 after permutation 810 with a label that asks the server to skip any computation that uses this tile.

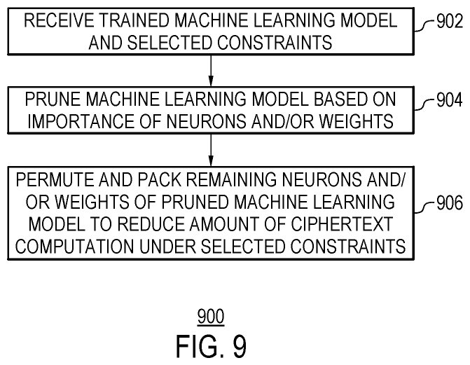

FIG. 9 is a process flow diagram of an example method that can pack, prune, and permute machine learning models under selected constraints. The method 900 can be implemented with any suitable computing device, such as the computing device 1200 of FIG. 12 or the system 100 of FIG. 1. For example, the method described below can be implemented by the computing device 102, the processor 1202, or the processor 1502 of FIGS. 1, 12, and 15.

At block 902, a processor receives a trained machine learning model and selected constraints. For example, the trained machine learning model may be encrypted or unencrypted. In some examples, the machine learning model may be a neural network, such as a convolutional neural network. In various examples, the selected constraints may include an inference accuracy constraints, a memory constraint, a latency constraint, or any combination thereof.

At block 904, the processor prunes the trained machine learning model based on an importance of neurons and weights. For example, the processor can set weights with values that do not exceed a threshold to zero. In some examples, the processor prunes weights of the machine learning model. For example, the processor may prune weights by setting weights with values that do not exceed a threshold to zero and flagging a particular packing shape, such as a tile of weights, as a zero tile to be disregarded.

At block 906, the processor permutes and packs remaining neurons and weights of the pruned machine learning model to reduce an amount of ciphertext computation under the selected constraints. In various examples, the processor can permute the machine learning model using a heuristic. For example, the heuristic may be a balanced clustering heuristic. In some examples, the processor can permute the machine learning model by alternating between permuting rows and columns of weight matrices corresponding to weights between layers of the machine learning model until a convergence is detected. In some examples, the processor can retrain the pruned machine learning model and execute the pruned machine learning model to obtain an accuracy score for the pruned machine learning model associated with a particular pruning threshold. In some examples, the processor can simulate the pruned and packed machine learning model to obtain a latency score and memory score associated with a number of packing shapes and pruning thresholds. For example, the pruned, permuted, and packed machine learning model may have a pruning threshold and a packing shape that minimizes an objective function based on the selected constraint. In various examples, the processor may prune and pack the machine learning model in tandem. For example, the processor may calculate a particular combination of pruning, permuting, and packing and apply the combination on the machine learning model such that a maximum number of neurons or weights are pruned from the machine learning model.

The process flow diagram of FIG. 9 is not intended to indicate that the operations of the method 900 are to be executed in any particular order, or that all of the operations of the method 900 are to be included in every case. Additionally, the method 900 can include any suitable number of additional operations. For example, the method 900 may further include executing a homomorphically encrypted inference using the pruned, permuted, and packed machine learning model. In some examples, the processor prunes neurons of the machine learning model. For example, the processor can remove the last few empty columns and empty rows of each of the pruned and permuted weight matrices. In various examples, the method 900 may also further include expanding the pruned, packed, and permuted machine learning model to utilize zero values within packing shapes.

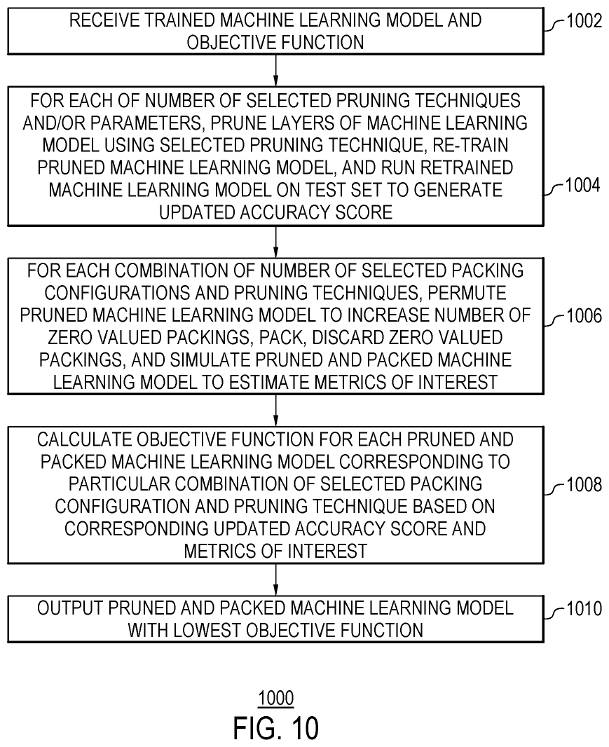

FIG. 10 is a process flow diagram of an example method that can select a combination of network packing, pruning, and permutation based on an objective function. The method 1000 can be implemented with any suitable computing device, such as the computing device 1200 of FIG. 12 or the system 100 of FIG. 1. For example, the method described below can be implemented by the computing device 102, the processor 1202, or the processor 1502 of FIGS. 1, 12, and 15.

At block 1002, a processor receives a trained machine learning model and an objective function. For example, the trained machine learning model may be encrypted or unencrypted. The objective function may include various constraints.

At block 1004, for each of a number of selected pruning techniques and parameters, the processor prunes layers of the machine learning model using the selected pruning technique, re-trains the pruned machine learning model, and runs the retrained machine learning model on a test set to generate an updated accuracy score. For example, each of the pruning techniques and parameters may be associated with a different updated accuracy score.

At block 1006, for each combination of a number of selected packing configurations and pruning techniques, the processor permutes the pruned machine learning model to increase a number of zero valued packings, packs the permuted, pruned machine learning model, discarding zero valued packings, and simulates the pruned and packed machine learning model to estimate metrics of interest. For example, the metrics of interest may include latency, memory usage, among other potential metrics of interest.

At block 1008, the processor calculates an objective function for each pruned and packed machine learning model corresponding to a particular combination of selected packing configuration and pruning technique based on a corresponding updated accuracy score and metrics of interest.

At block 1010, the processor outputs a pruned and packed machine learning model with a lowest objective function. For example, a pruned and packed machine learning model that minimizes the objective function given a particular set of constraints may be output.

The process flow diagram of FIG. 10 is not intended to indicate that the operations of the method 1000 are to be executed in any particular order, or that all of the operations of the method 1000 are to be included in every case. Additionally, the method 1000 can include any suitable number of additional operations. For example, the method 1000 may further include executing a homomorphically encrypted inference using the pruned, permuted, and packed machine learning model. In some examples, the method 1000 may include expanding the pruned, packed, and permuted machine learning model to undo pruning for tiles that do not have all zero values, and use retrain these tiles to improve the inference accuracy of the network. For example, each of the unpruned tiles may have a full set of values instead of having the zero values from pruning.

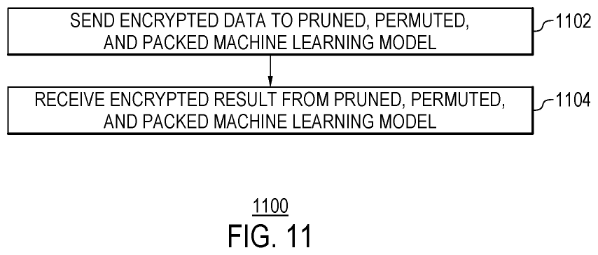

FIG. 11 is a process flow diagram of an example method that can generate encrypted results based on encrypted data using a machine learning model packed using pruning and permutation. The method 1100 can be implemented with any suitable computing device, such as such as the computing device 1200 of FIG. 12 or the system 200 of FIG. 2. For example, the method described below can be implemented by the pruned, permuted, and packed machine learning model 116 of FIG. 2.

At block 1102, a processor sends encrypted data to a pruned, permuted, and packed machine learning model. For example, the encrypted data may include encrypted images, or any other type of data to be classified. In various examples, the pruned, permuted, and packed machine learning model may have been pruned, permuted, and packed using techniques described herein, such as via methods 900 or 1000 of FIGS. 9 and 10 above.

At block 1104, the processor receives an encrypted result from the pruned, permuted, and packed machine learning model. For example, the encrypted result may be a classification or an image or other data.

The process flow diagram of FIG. 11 is not intended to indicate that the operations of the method 1100 are to be executed in any particular order, or that all of the operations of the method 1100 are to be included in every case. Additionally, the method 1100 can include any suitable number of additional operations. For example, the method 1100 may include decrypting the encrypted result using a key corresponding to a key used to encrypt the encrypted data that was sent to the pruned, permuted, and packed machine learning model.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 12 is block diagram of an example computing device that can pack, prune, and permute machine learning model under selected constraints. The computing device 1200 may be for example, a server, desktop computer, laptop computer, tablet computer, or smartphone. In some examples, computing device 1200 may be a cloud computing node. Computing device 1200 may be described in the general context of computer system executable instructions, such as program modules, being executed by a computer system. Generally, program modules may include routines, programs, objects, components, logic, data structures, and so on that perform particular tasks or implement particular abstract data types. Computing device 1200 may be practiced in distributed cloud computing environments where tasks are performed by remote processing devices that are linked through a communications network. In a distributed cloud computing environment, program modules may be located in both local and remote computer system storage media including memory storage devices.

The computing device 1200 may include a processor 1202 that is to execute stored instructions, a memory device 1204 to provide temporary memory space for operations of said instructions during operation. The processor can be a single-core processor, multi-core processor, computing cluster, or any number of other configurations. The memory 1204 can include random access memory (RAM), read only memory, flash memory, or any other suitable memory systems.

The processor 1202 may be connected through a system interconnect 1206 (e.g., PCI®, PCI-Express®, etc.) to an input/output (I/O) device interface 1208 adapted to connect the computing device 1200 to one or more I/O devices 1210. The I/O devices 1210 may include, for example, a keyboard and a pointing device, wherein the pointing device may include a touchpad or a touchscreen, among others. The I/O devices 1210 may be built-in components of the computing device 1200, or may be devices that are externally connected to the computing device 1200.

The processor 1202 may also be linked through the system interconnect 1206 to a display interface 1212 adapted to connect the computing device 1200 to a display device 1214. The display device 1214 may include a display screen that is a built-in component of the computing device 1200. The display device 1214 may also include a computer monitor, television, or projector, among others, that is externally connected to the computing device 1200. In addition, a network interface controller (NIC) 1216 may be adapted to connect the computing device 1200 through the system interconnect 1206 to the network 1218. In some embodiments, the NIC 1216 can transmit data using any suitable interface or protocol, such as the internet small computer system interface, among others. The network 1218 may be a cellular network, a radio network, a wide area network (WAN), a local area network (LAN), or the Internet, among others. An external computing device 1220 may connect to the computing device 1200 through the network 1218. In some examples, external computing device 1220 may be an external webserver 1220. In some examples, external computing device 1220 may be a cloud computing node.

The processor 1202 may also be linked through the system interconnect 1206 to a storage device 1222 that can include a hard drive, an optical drive, a USB flash drive, an array of drives, or any combinations thereof. In some examples, the storage device may include a model pruner module 1224, a model permuter module 1226, and a model packer module 1228. The model pruner module 1224 can receive a machine learning model and one or more selected constraints. For example, the selected constraints may include an inference accuracy constraint, a memory constraint, a latency constraint, an amortized latency, power constraint, energy constraint, or any combination thereof. The model pruner module 1224 can prune the machine learning model based on an importance of neurons and weights. For example, the importance may be based on the criticality of the neurons. The criticality of the neurons may be a measure of accuracy loss resulting in response to removing a particular neuron. In some examples, the importance may be based on values of the weights. For example, a pruning threshold may be used to set weights with values not exceeding the threshold to zero. The model pruner module 1224 can eliminate an operation from the machine learning model. In some examples, the operation may be associated with one or more neurons. The model permuter module 1226 and the model packer module 1228 can permute and pack remaining neurons and weights of the pruned machine learning model to reduce an amount of ciphertext computation under a selected constraint. In various examples, the model permuter module 1226 can permute the machine learning model using any suitable heuristic, such as a balanced clustering heuristic. For example, the balanced clustering heuristic may be a balanced k-means clustering. In some examples, the model permuter 1226 can permute the machine learning model using alternating permutations of rows and columns. The model packer module 1228 can pack the machine learning model using any suitable packing method. The model packer module 1228 can use a packing method that reduces the ciphertext computation by maximizing a number of zero values packing shapes. In some examples, the model pruner module 1224 and the model packer module 1228 can prune and pack in tandem. For example, the pruning and packing may be based on a combination of pruning, packing, and permutation determined using an objective function. The objective function evaluator 1230 can calculate an objective function for each of any number of combinations of packing methods, permutation techniques, and pruning threshold values or parameters.

It is to be understood that the block diagram of FIG. 12 is not intended to indicate that the computing device 1200 is to include all of the components shown in FIG. 12. Rather, the computing device 1200 can include fewer or additional components not illustrated in FIG. 12 (e.g., additional memory components, embedded controllers, modules, additional network interfaces, etc.). For example, the computing device 1200 may also include a model expander to expand the pruned, packed, and permuted model to undo pruning for tiles that do not have all zero values, and use retrain these tiles to improve the inference accuracy of the network. In some examples, the computing device 1200 may further include an execution module to perform execution of a homomorphically encrypted inference of the pruned, permuted, and packed machine learning model. Furthermore, any of the functionalities of the model pruner 1224, the model permuter module 1226, and the model packer module 1228 may be partially, or entirely, implemented in hardware and/or in the processor 1202. For example, the functionality may be implemented with an application specific integrated circuit, logic implemented in an embedded controller, or in logic implemented in the processor 1202, among others. In some embodiments, the functionalities of the model pruner module 1224, model permuter module 1226, and model packer module 1228 can be implemented with logic, wherein the logic, as referred to herein, can include any suitable hardware (e.g., a processor, among others), software (e.g., an application, among others), firmware, or any suitable combination of hardware, software, and firmware.

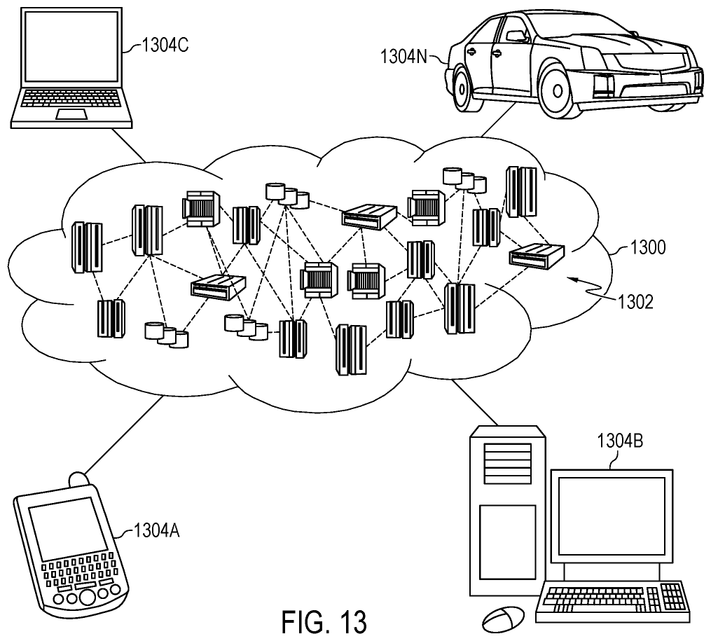

Referring now to FIG. 13, illustrative cloud computing environment 1300 is depicted. As shown, cloud computing environment 1300 includes one or more cloud computing nodes 1302 with which local computing devices used by cloud consumers, such as, for example, personal digital assistant (PDA) or cellular telephone 1304A, desktop computer 1304B, laptop computer 1304C, and/or automobile computer system 1304N may communicate. Nodes 1302 may communicate with one another. They may be grouped (not shown) physically or virtually, in one or more networks, such as Private, Community, Public, or Hybrid clouds as described hereinabove, or a combination thereof. This allows cloud computing environment 1300 to offer infrastructure, platforms and/or software as services for which a cloud consumer does not need to maintain resources on a local computing device. It is understood that the types of computing devices 1304A-N shown in FIG. 13 are intended to be illustrative only and that computing nodes 1302 and cloud computing environment 1300 can communicate with any type of computerized device over any type of network and/or network addressable connection (e.g., using a web browser).

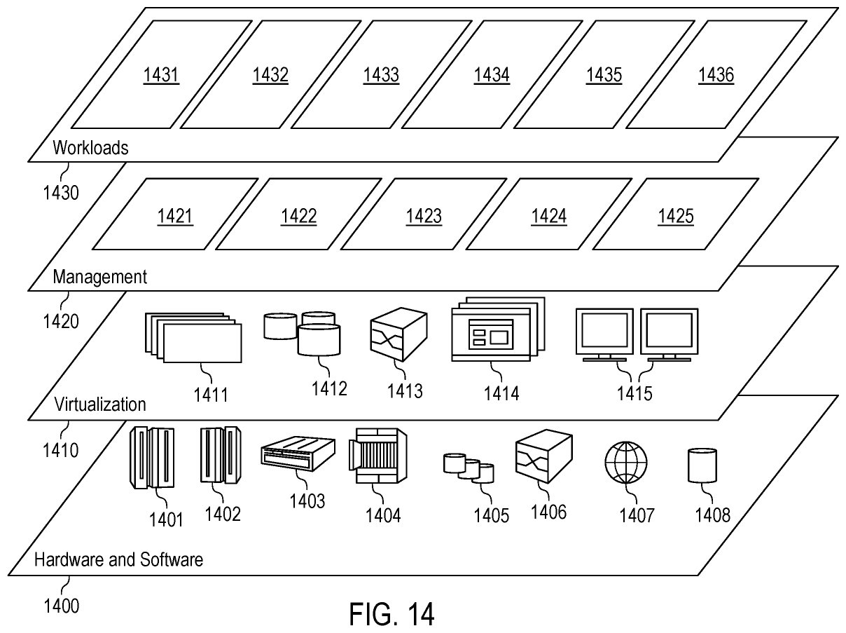

Referring now to FIG. 14, a set of functional abstraction layers provided by cloud computing environment 1300 (FIG. 13) is shown. It should be understood in advance that the components, layers, and functions shown in FIG. 14 are intended to be illustrative only and embodiments of the invention are not limited thereto. As depicted, the following layers and corresponding functions are provided:

Hardware and software layer 1400 includes hardware and software components. Examples of hardware components include: mainframes 1401; RISC (Reduced Instruction Set Computer) architecture based servers 1402; servers 1403; blade servers 1404; storage devices 1405; and networks and networking components 1406. In some embodiments, software components include network application server software 1407 and database software 1408.

Virtualization layer 1410 provides an abstraction layer from which the following examples of virtual entities may be provided: virtual servers 1411; virtual storage 1412; virtual networks 1413, including virtual private networks; virtual applications and operating systems 1414; and virtual clients 1415.

In one example, management layer 1420 may provide the functions described below. Resource provisioning 1421 provides dynamic procurement of computing resources and other resources that are utilized to perform tasks within the cloud computing environment. Metering and Pricing 1422 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1423 provides access to the cloud computing environment for consumers and system administrators. Service level management 1424 provides cloud computing resource allocation and management such that required service levels are met. Service Level Agreement (SLA) planning and fulfillment 1425 provide pre-arrangement for, and procurement of, cloud computing resources for which a future requirement is anticipated in accordance with an SLA.

Workloads layer 1430 provides examples of functionality for which the cloud computing environment may be utilized. Examples of workloads and functions which may be provided from this layer include: mapping and navigation 1431; software development and lifecycle management 1432; virtual classroom education delivery 1433; data analytics processing 1434; transaction processing 1435; and machine learning model optimization 1436.

The present invention may be a system, a method and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

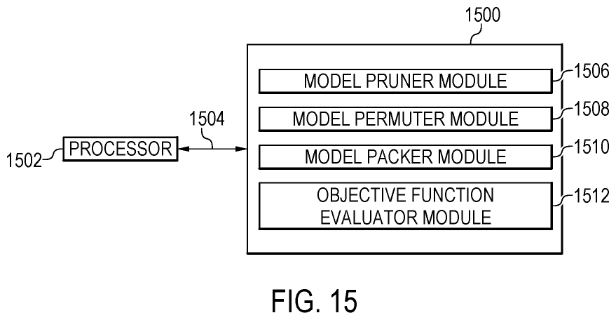

Referring now to FIG. 15, a block diagram is depicted of an example tangible, non-transitory computer-readable medium 1500 that can pack, prune, and permute machine learning model under selected constraints. The tangible, non-transitory, computer-readable medium 1500 may be accessed by a processor 1502 over a computer interconnect 1504. Furthermore, the tangible, non-transitory, computer-readable medium 1500 may include code to direct the processor 1502 to perform the operations of the methods 900 and 1000 of FIGS. 9 and 10.

The various software components discussed herein may be stored on the tangible, non-transitory, computer-readable medium 1500, as indicated in FIG. 15. For example, a model pruner module 1506 includes code to prune a machine learning model based on an importance of neurons and weights. The model pruner module 1506 also includes code to set weights with values that do not exceed a threshold to zero. In some examples, the model pruner module 1506 includes code to. In some examples, the model pruner module 1506 includes code to. A model permuter module 1508 includes code to permute remaining neurons and weights of the pruned machine learning model to reduce an amount of ciphertext computation under a selected constraint. The model permuter module 1508 further includes code to permute the machine learning model using a heuristic. For example, the model permuter module 1508 may include code to permute the machine learning model using a balanced clustering. In some examples, the model permuter module 1508 may include code to alternate between permuting rows and columns of weight matrices corresponding to weights between layers of the machine learning model until a convergence is detected. A model packer module 1510 includes code to pack the neurons and weights of the pruned machine learning model to reduce an amount of ciphertext computation under a selected constraint. The model packer module 1510 also includes code to. An objective function evaluator module 1512 includes code to simulate the pruned and packed machine learning model to obtain a latency score and memory score associated with a number of packing shapes and pruning thresholds. For example, the objective function evaluator module 1512 includes code to detect a pruning threshold and a packing shape that minimizes an objective function based on the selected constraint. In some examples, the objective function evaluator module 1512 includes code to retrain the pruned machine learning model and execute the pruned machine learning model to obtain an accuracy score for the pruned machine learning model associated with a particular pruning threshold.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIG. 15 may be included within the tangible, non-transitory, computer-readable medium 1500, depending on the specific application. For example, the computer-readable medium 1500 may also include code to execute a homomorphically encrypted inference using the pruned, permuted, and packed machine learning model. In some examples, the computer-readable medium 1500 may also include code to expand the pruned and permuted machine learning model to un-prune zero values within partially-zero-valued pruned packing shapes.

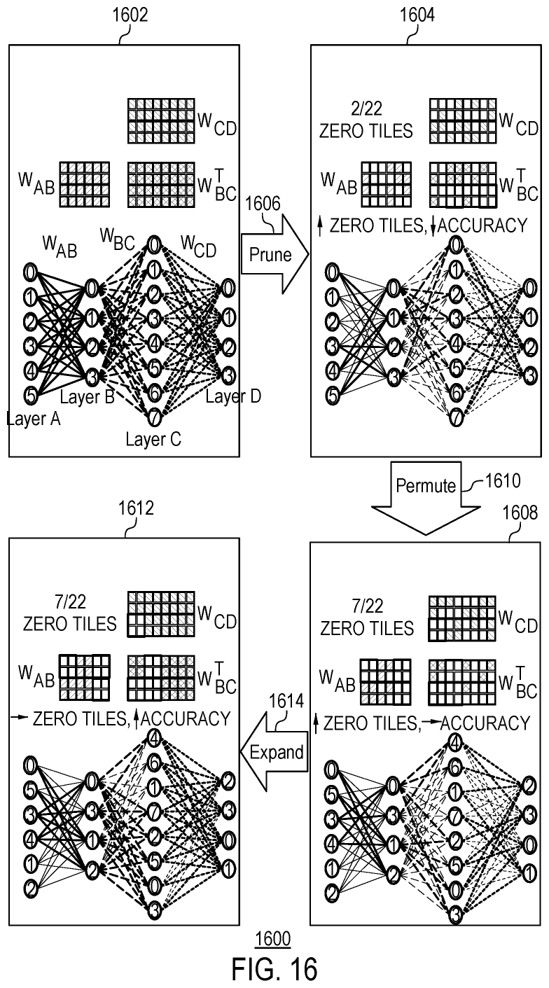

FIG. 16 is a diagram illustrating an example process of weight pruning and permutation with an example expansion. The example process 1600 can be implemented with any suitable computing device, such as the computing device 1200 of FIG. 12 or the system 100 of FIG. 1 with optional model expander added. For example, the process 700 can be implemented by the computing device 102, the processor 1202, or the processor 1502 of FIGS. 1, 12, and 15.

At block 1602, the processor receives a trained neural network with layers A, B, C, D and weights W_{AB}, W_{BC}, W_{CD} The transposed matrix of weights W_{BC} is labeled as W_{BC}^{T}. Before pruning, the weight matrices W_{AB}, W_{BC}^{T}, W_{CD} do not contain any zero values.

At block 1604, a number of weight values have been pruned via pruning 1606 to zero, resulting in two zero tiles that contain only zero values. As shown, the accuracy of the resulting neural network may be reduced at block 1604, but the efficiency is increased.

At block 1608, the order of the weight matrices has been permuted via a permute operation 1610 to increase the number of zero tiles to a total of seven zero tiles. As shown in block 1608, the accuracy is not affected, but efficiency is increased.

At block 1612, the accuracy of the neural network has been increased via an expand operation 1614. In particular, the zero values of partially zero tiles have been utilized by the extend operation 1614 in order to increase the accuracy of the neural network. In particular, the extend operation 1614 may un-prune any zero values in partially zero tiles so that the values may be used for training. Thus, block 1612 may restore most of the accuracy loss of block 1604.

It is to be understood that the diagram of FIG. 16 is not intended to indicate that the process 1600 is to include all of the components shown in FIG. 16. Rather, the process 1600 can include fewer or additional components not illustrated in FIG. 16 (e.g., additional layers, neurons, weights, tile shapes, or additional types or iterations of permutations, or may include a final packing, etc.).

FIG. 17 is a diagram illustrating an example set of different combinations of pruning, permutation, expansion, and packing, according to embodiments described herein. The example combinations can be implemented by the system 100 to generate a pruned, permuted, and packed learning model or pruned, permuted, expanded, and packed machine learning model.

FIG. 17 shows a variety of combinations of training, pruning, permuting, expanding, retraining, and packing, according to techniques described herein. These different combinations are referred to by the acronyms P2, P2T, P3, P3E, P4, P4E, P5E, and P6. As shown in FIG. 17, each of the combinations starts by training a machine learning model. For example, the machine learning model may be a neural network. In various examples, once the trained machine learning model is ready, a processor may prune neurons or weights of the trained machine learning model based on some criterion. All strategies except for P2T first perform pruning by one of the six pruning configurations discussed in FIG. 1 above. In the example of P2T, the initial pruning is a packing-based pruning. Because P2T performs a packing-based pruning, and because we prune complete tiles, there is no need for the processor to perform further steps such as permutations or expansion in P2T. In contrast, when performing a non-packing-aware pruning, the pruned weights or neurons may not necessarily be organized in a nice way that will lead to a wide cancellation of tile operations. Therefore, the processor may apply extra operations, such as permutation or expansion to improve the efficient use of tiles. As described above, the permute operation may include permuting the rows and columns of the weight matrices after the pruning operation to concentrate zero elements together. The expand operation reverses the pruning operation. For example, the expand operation may include searching for tiles that do not hold only zero values and unpruning the zero elements inside these tiles. In the examples of P3, P3E, P4, P4E, P5E, and P6 a permutation is thus also then performed.

In the example of P4, instead of expanding the model as in P3, the processor can execute a second pruning-aware-packing step to reduce all incomplete zero tiles. In the examples of P5 and P6, after the first permutation step, the processor can execute a semi-packing-aware-pruning method Prune^{semi-pack} that locates tiles that are partially zeroed and prunes some more elements inside them but not all. Subsequently, the processor can reapply the permutation algorithm. In this manner, the processor can help the permutation heuristic while sticking with the pruning configuration that was originally applied. After the second permutation step, the processor may determine whether to expand or packing-aware prune tiles based on the number of zeros inside them. Finally, for all the combinations, the processor may execute a retraining of the machine learning model to increase accuracy and a final packing of the retrained machine learning model. In various examples, these integrated combinations of permutation, expansion, pruning and packing provide various trade-offs between accuracy, performance, and memory consumption and thus provide options for various use cases.

It is to be understood that the diagram of FIG. 17 is not intended to indicate that the set of 1700 is to include all of the components shown in FIG. 17. Rather, the process 1700 can include fewer or additional components not illustrated in FIG. 17 (e.g., additional training, pruning, permutation, expansion, retraining, or packing, etc.). Thus, FIG. 17 is not intended as being an exhaustive list of combinations of the various operations described herein.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
prune a machine learning model based on an importance of neurons or weights; and
permute and pack remaining neurons or weights of the pruned machine learning model to reduce an amount of ciphertext computation under a selected constraint.

2. The system of claim 1, wherein the processor is to prune and pack in tandem.

3. The system of claim 1, wherein the importance is based on the criticality of the neurons.

4. The system of claim 1, wherein the importance is based on values of the weights.

5. The system of claim 1, wherein the selected constraint comprises an inference accuracy constraint.

6. The system of claim 1, wherein the selected constraint comprises a memory constraint.

7. The system of claim 1, wherein the selected constraint comprises a latency constraint.

8. The system of claim 1, wherein pruning the machine learning model comprises eliminating an operation from the machine learning model.

9. The system of claim 1, wherein the ciphertext computation comprises an execution of a homomorphically encrypted inference of the pruned, permuted, and packed machine learning model.

10. A computer-implemented method, comprising:
pruning, via a processor, a machine learning model based on an importance of neurons or weights; and
permuting and packing, via the processor, remaining neurons or weights of the pruned machine learning model to reduce an amount of ciphertext computation under a selected constraint.

11. The computer-implemented method of claim 10, further comprising executing a homomorphically encrypted inference using the pruned, permuted, and packed machine learning model.

12. The computer-implemented method of claim 10, wherein pruning the machine learning model comprises pruning a weight of the machine learning model by setting weights with values that do not exceed a threshold to zero.

13. The computer-implemented method of claim 10, wherein pruning the machine learning model comprises pruning a neuron of the machine learning models.

14. The computer-implemented method of claim 10, wherein permuting the machine learning model comprises using a balanced clustering.

15. The computer-implemented method of claim 10, wherein permuting the machine learning model comprises alternating between permuting rows and columns of weight matrices corresponding to weights between layers of the machine learning model until a convergence is detected.

16. The computer-implemented method of claim 10, further comprising expanding the pruned and permuted machine learning model to un-prune zero values within partially-zero-valued pruned packing shapes.

17. The computer-implemented method of claim 10, further comprising simulating the pruned and packed machine learning model to obtain a latency score and memory score associated with a plurality of packing shapes and pruning thresholds, wherein the pruned, permuted, and packed machine learning model comprises a pruning threshold and a packing shape that minimizes an objective function based on the selected constraint.

18. A computer program product for pruning and packing machine learning models, the computer program product comprising a computer-readable storage medium having program code embodied therewith, the program code executable by a processor to cause the processor to:
prune a machine learning model based on an importance of neurons or weights; and
permute and pack remaining neurons or weights of the pruned machine learning model to reduce an amount of ciphertext computation under a selected constraint.

19. The computer program product of claim 18, further comprising program code executable by the processor to set weights with values that do not exceed a threshold to zero.

20. The computer program product of claim 18, further comprising program code executable by the processor to permute the machine learning model using a heuristic.

21. The computer program product of claim 18, further comprising program code executable by the processor to permute the machine learning model using a balanced clustering.

22. The computer program product of claim 18, further comprising program code executable by the processor to alternate between permuting rows and columns of weight matrices corresponding to weights between layers of the machine learning model until a convergence is detected.

23. The computer program product of claim 18, further comprising program code executable by the processor to retrain the pruned machine learning model and execute the pruned machine learning model to obtain an accuracy score for the pruned machine learning model associated with a particular pruning threshold.

24. The computer program product of claim 18, further comprising program code executable by the processor to simulate the pruned and packed machine learning model to obtain a latency score and memory score associated with a plurality of packing shapes and pruning thresholds, wherein the pruned, permuted, and packed machine learning model comprises a pruning threshold and a packing shape that minimizes an objective function based on the selected constraint.

25. The computer program product of claim 18, further comprising program code executable by the processor to execute a homomorphically encrypted inference using the pruned, permuted, and packed machine learning model.
